(19) United States
(12) Patent Application Publication
(10) Pub. No.: US 2024/0152204 A1
(43) Pub. Date: May 9, 2024

(54) EYE TRACKING SYSTEM WITH CO-AXIAL PATTERN PROJECTION AND CAPTURE

(71) Applicant: Meta Platforms Technologies, LLC, Menlo Park, CA (US)

(72) Inventors: Yatong An, Redmond, WA (US); Youmin Wang, Bellevue, WA (US)

(21) Appl. No.: 18/377,551

(22) Filed: Oct. 6, 2023

Related U.S. Application Data
(60) Provisional application No. 63/422,659, filed on Nov. 4, 2022.

(51) Int. Cl. G06F 3/01; G02B 27/01; G02B 27/28; G06V 10/141; G06V 40/18

(52) U.S. Cl. CPC G06F 3/013; G02B 27/0172; G02B 27/283; G06V 10/141; G06V 40/193

(57) ABSTRACT

Systems and methods of a co-axial eye tracking system include a projector, a camera, and a beam splitter. The projector is configured to emit a light pattern along a first light path to an eyebox region. The camera is configured to capture an image of a reflection of the light pattern along a second light path from the eyebox region. A beam splitter is positioned to at least partially align the first light path with the second light path so a first optical axis of the projector is optically co-axial with a second optical axis of the camera, with respect to the eyebox region.

### CROSS-REFERENCE TO RELATED APPLICATIONS

This application claims priority to U.S. provisional Application No. 63/422,659 filed Nov. 4, 2022, which is hereby incorporated by reference.

### TECHNICAL FIELD

This disclosure relates generally to head-mounted devices, and in particular to eye tracking.

### BACKGROUND INFORMATION

Various techniques exist for determining an eye orientation. However, current approaches for determining eye orientation have deficiencies when it comes to determining eye orientation for eye tracking operations.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a block diagram of an example of a co-axial eye tracking system for a head-mounted device, in accordance with aspects of the disclosure.

FIG. 2 illustrates a perspective view of an example of a head-mounted device having a co-axial eye tracking system, in accordance with aspects of the disclosure.

FIGS. 3A, 3B, and 3C illustrate example implementations of a light pattern that may be used for eye tracking, in accordance with aspects of the disclosure.

FIG. 4 illustrates a flow diagram of a process for co-axial eye tracking with a head-mounted device, in accordance with aspects of the disclosure.

### DETAILED DESCRIPTION

Embodiments of an eye tracking system with co-axial pattern projection and capture are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A head-mounted device may use an eye tracking system to capture feedback from users, to facilitate operation of user interfaces, and to adjust images displayed to users, among other things. Fringe (or pattern) projection is a very promising technique in eye tracking applications. Traditional fringe projection system use a stereo vision setup in which the projector and camera see the object from two different perspectives (e.g., from two different angles). However, this setup usually suffers from issues related to occlusions and shadows. For example, a light source may illuminate the eye from a first perspective that may include illuminating an eyelash or eyelid. The obstruction (e.g., eyelash, eyelid, etc.) may cast a shadow. If a camera images the eye from a second perspective (different from the first), the camera may capture the cast shadow, which may further complicate determination of eye orientation and may need additional image processing. Either the camera is partially blocked from the same view as the projector or the projector casts shadows (e.g., of eyelashes) that inject noise into images of the eye or eyebox region.

In accordance with aspects of the disclosure, an eye tracking system is configured to enable co-axial pattern projection and capture for a head-mounted device. The eye tracking system includes a projector, a camera (e.g., image sensor), and a beam splitter. The projector, camera, and beam splitter may be positioned in/on a frame or on one or more arms of the head-mounted device. The beam splitter is positioned to align an optical axis of the projector with an optical axis of the camera. In operation, the beam splitter may receive a light pattern from the projector and direct (e.g., reflect) the light pattern to an eyebox region of the head-mounted device (e.g., to a user's eye). The projected light pattern may include various patterns, such as a fringe line pattern, a circular pattern, or a dot pattern to enable the eye tracking system (e.g., a controller) to determine an orientation of an eye. The beam splitter may receive a reflection of the light from the eyebox region and may direct (e.g., transmit) the reflection of the light to the camera. The camera may capture an image of the reflected light and may generate image data. The image data may be provided to a controller to enable the controller to determine an eye orientation or a gaze vector based on the image and based on the light pattern. Advantageously, the disclosed system may be low-cost, be easy to implement, and be void of moving mechanical parts. By aligning the optical axis of the fringe projector and camera, the two devices may see the object in the same perspective, to alleviate shadow or occlusion problems.

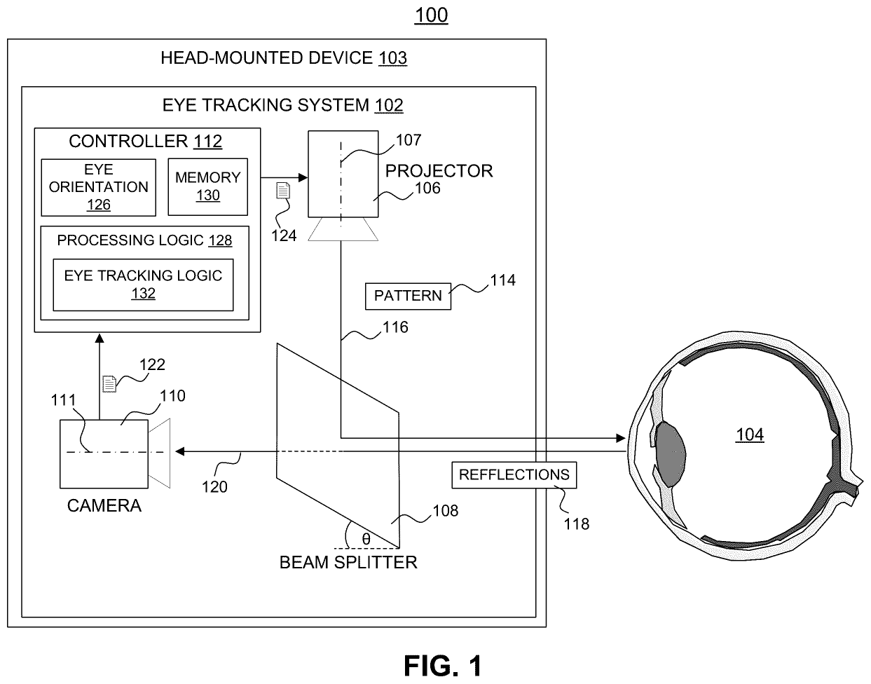

The apparatus, system, and method for co-axial eye tracking in a head-mounted device that are described in this disclosure include improvements in determining eye orientation and/or relative eye position, which may be used to support eye tracking operations in a head-mounted device. These and other embodiments are described in more detail in connection with FIGS. 1-4.

FIG. 1 illustrates an example of an ocular environment 100 having an eye tracking system 102 with co-axial pattern projection and capture, in accordance with aspects of the disclosure. Eye tracking system 102 is configured to determine an orientation of an eye 104 using a pattern 114 of light that is at least partially projected and captured along a single light path (e.g., co-axially), according to an embodiment. Eye tracking system 102 may be configured to perform eye tracking operations based on the orientation or position of eye 104 that is within an eyebox region of head-mounted device 103, according to an embodiment. A head-mounted device, such as head-mounted device 103, is one type of smart device. In some contexts, head-mounted device 103 is also a head-mounted display (HMD) that is configured to provide artificial reality. Artificial reality is a form of reality that has been adjusted in some manner before presentation to the user, which may include, e.g., virtual reality (VR), augmented reality (AR), mixed reality (MR), hybrid reality, or some combination and/or derivative thereof.

Eye tracking system 102 includes various components configured to support co-axial pattern projection and capture, in accordance with aspects of the disclosure. Eye tracking system 102 includes a projector 106, a beam splitter 108, a camera 110, and a controller 112, according to an embodiment. Projector 106 is configured to provide a pattern 114 to determine a shape, an orientation, or other characteristics of eye 104, according to an embodiment. To produce pattern 114, projector 106 may include one or more light sources (e.g., coherent light sources), one more beam splitters, one or more polarizers, and the like, according to an embodiment. The one or more light sources that may include one or more of light emitting diodes (LEDs), photonic integrated circuit (PIC) based illuminators, micro light emitting diode (micro-LED), an edge emitting LED, a superluminescent diode (SLED), a vertical cavity surface emitting laser (VCSEL), or another type of laser. A polarizer may include a quarter-wave plate, half-wave plate, or similar optical element.

Pattern 114 may be implemented as an interference pattern, according to an embodiment. As an interference pattern, pattern 114 may include a number of fringe lines that are representative of constructive and destructive interference of one or more light beams from projector 106. The fringe lines may sinusoidally alternate in intensity and may be observed as bright lines that gradually become dark lines. The dark lines may represent destructive interference and the bright lines may represent constructive interference of the one or more light beams. Pattern 114 may include fringe lines oriented vertically, horizontally, or diagonally, according to an embodiment. Pattern 114 may include bright and dark lines that are concentric and alternate between light and dark in a circular pattern. In one embodiment, pattern 114 includes a number of dots (e.g., in a random pattern), which may be implemented by illuminating a speckled filter or optical element with one or more light sources. Pattern 114 may propagate from projector 106 to eye 104 along a light path 116.

Beam splitter 108 optically couples projector 106 to eye 104 and optically couples eye 104 to camera 110, according to an embodiment. Beam splitter 108 is positioned between projector 106, eye 104, and camera 110 to align an optical axis 107 of projector 106 with an optical axis 111 of camera 110, according to an embodiment. Beam splitter 108 may be implemented as a 50-50 beam splitter, or as a polarization beam splitter, according to various embodiments. Beam splitter 108 may be configured to redirect (e.g., reflect) pattern 114 towards eye 104. Beam splitter 108 may be configured to direct (e.g., transmit) reflections 118 of pattern 114 from eye 104 (through beam splitter 108) to camera 110, according to an embodiment. Beam splitter 108 may be oriented at an angle θ to redirect pattern 114 towards eye 104. In one implementation, beam splitter 108 passes/transmits pattern 114 to eye 104 and redirects reflections 118 (e.g., using reflection) from eye 104 to camera 110.

Beam splitter 108 may be implemented as a polarization-based beam splitter, according to an embodiment. Pattern 114 may be emitted by projector 106 with a first polarization orientation (e.g., vertically polarized. Upon reflection off of eye 104, reflections 118 may at least partially have a second polarization orientation (e.g., horizontally polarized, circularly polarized, etc.). Beam splitter 108 may be configured to reflect light having the first polarization orientation and may be configured to pass or transmit light having a second polarization orientation, to align projector 106 to be co-axial with camera 110, according to an embodiment. Reflections 118 may travel along a light path 120 between eye 104 and camera 110, through beam splitter 108, according to an embodiment.

Beam splitter 108 optically (e.g., co-axially) aligns optical axis 107 of projector 106 with optical axis 111 of camera 110, according to an embodiment. Beam splitter 108 aligns the optical axes by at least partially aligning light path 116 with light path 120, according to an embodiment. Beam splitter 108 aligns light path 116 with light path 120 in a portion of the light paths that is between eye 104 and beam splitter 108, according to an embodiment.

Camera 110 may include an image sensor, one or more lenses, one or more polarizers, and one or more filters, according to an embodiment. The image sensor may be implemented as various types of image sensors, such as a complementary metal-oxide semiconductor (CMOS) image sensor, a light field sensor, or an event camera. Camera 110 may be configured to be responsive to light that is not in the visible spectrum (e.g., light in the near-infrared spectrum). The filters or polarizers may enable camera 110 to capture light having a particular polarization orientation (e.g., the second polarization orientation) and/or capture light having a particular wavelength or band of wavelengths (e.g., infrared or near infrared), according to an embodiment. Camera 110 captures an image of reflections 118 and provides image data 122 to controller 112 for processing, according to an embodiment.

Controller 112 is coupled to projector 106 and camera 110, in accordance with aspects of the disclosure. Controller 112 may be configured to provide signals 124 that cause projector 106 to operate (e.g., transmit pattern 114). Controller 112 receives image data 122 and determines and an eye orientation 126 based on image data 122, according to an embodiment.

Controller 112 may include processing logic 128 and memory 130 and may be configured to at least partially control eye tracking system 102. Processing logic 128 may include eye tracking logic 132 and may be configured to provide information (e.g., user experience buttons, text, graphics, and/or other elements) to a display of head-mounted device 103 based on orientation characteristics (e.g., a relative or absolute orientation) of eye 104. Processing logic 128 may include circuitry, logic, instructions stored in a machine-readable storage medium, ASIC circuitry, FPGA circuitry, and/or one or more processors. Processing logic 128 may be coupled to memory 130 (e.g., volatile and/or non-volatile) to perform one or more (computer-readable) instructions stored on memory 130.

Controller 112 (e.g., processing logic 128) may use one or more of a variety of techniques for determining eye orientation 126 from image data 122. For example, controller 112 may use changes in pattern 114 to determine rotation or displacement of eye 104. The fringe lines of pattern 114 may shift in phase when eye 104 rotates. The phase shift of the fringe lines may appear as displacement of the fringe lines (e.g., left, right, up, down) when observed or captured by camera 110. Controller 112 may be configured to detect the phase shifts and determine a relative eye position or orientation based on image data 122. In one embodiment, controller 112 may be configured to calculate or measure one or more frequency components of pattern 114, and the frequency components of pattern 114 may shift based on movement or displacement of eye 104. Frequency components may be determined by applying, for example, a Fourier transform to image data 122. Controller 112 may be configured to quantify the changes in frequency of pattern 114 and determine eye orientation 126 (e.g., relative or absolute) based on the determined frequency changes.

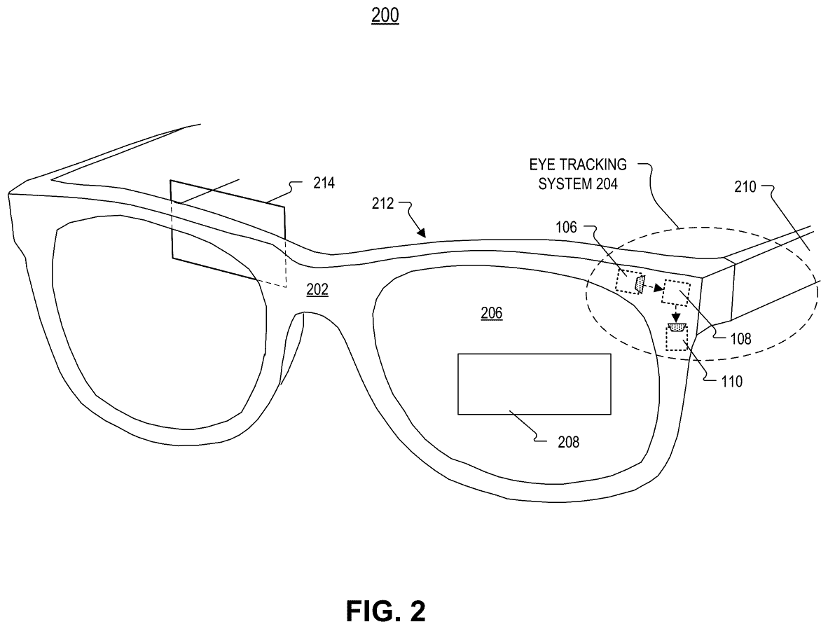

FIG. 2 illustrates a perspective view of an example of a head-mounted device 200, in accordance with aspects of the disclosure. Head-mounted device 200 is an example implementation of head-mounted device 103 (shown in FIG. 1). Head-mounted device 200 may include a frame 202, an eye tracking system 204, a lens assembly 206, and a display 208, in accordance with aspects of the disclosure. Eye tracking system 204 may be configured to determine an orientation of an eye that is located in an eyebox region 214 of head-mounted device 200. Eyebox region 214 is the region within which an eye might rest while a user wears head-mounted device 200, according to an embodiment. Eye tracking system 204 may be implemented into various locations of frame 202, such as within an arm 210 or a front portion 212 of frame 202. For example, portions of projector and/or camera may be incorporated into arm 210 and/or into the top, side, middle, or bottom of front portion 212. The projector and/or camera may be at least partially integrated into lens assembly 206, according to an embodiment. Display 208 may be integrated into or positioned onto lens assembly 206. Display 208 may be integrated into a display layer of a stack of optical layers that define lens assembly 206.

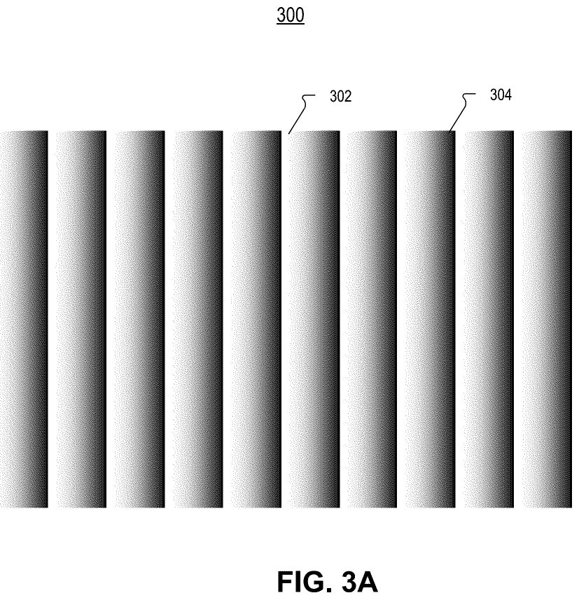

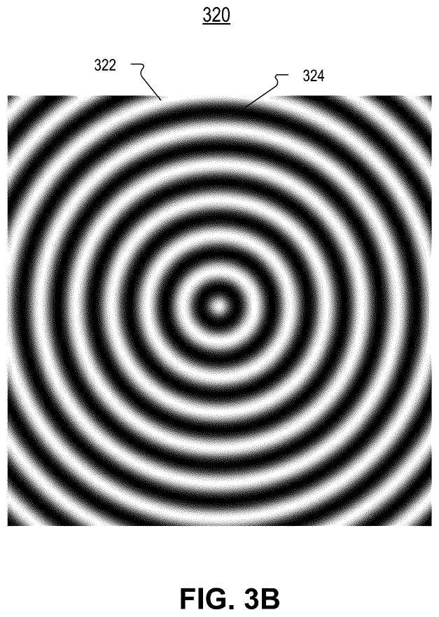

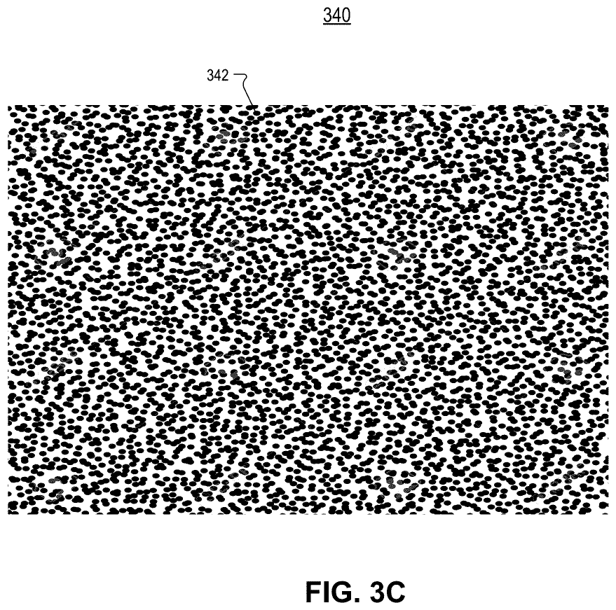

FIGS. 3A, 3B, and 3C illustrate embodiments of a pattern that may be used by an eye tracking system to determine an eye orientation. Patterns 300, 320, and 340 are example implementations of pattern 114 (shown in FIG. 1). Pattern 300 may include bright fringe lines 302 and dark fringe lines 304 oriented in alternating straight lines (e.g., vertical, horizontal, diagonal, etc.). A pattern 320 may include bright lines 322 and dark lines 324 oriented in alternating concentric lines. Bright lines 322 and dark lines 324 may be generated as interference fringe lines or by illuminating a pattern mask with a light source. Pattern 340 may include a number of dots 342 that are, for example, randomly distributed.

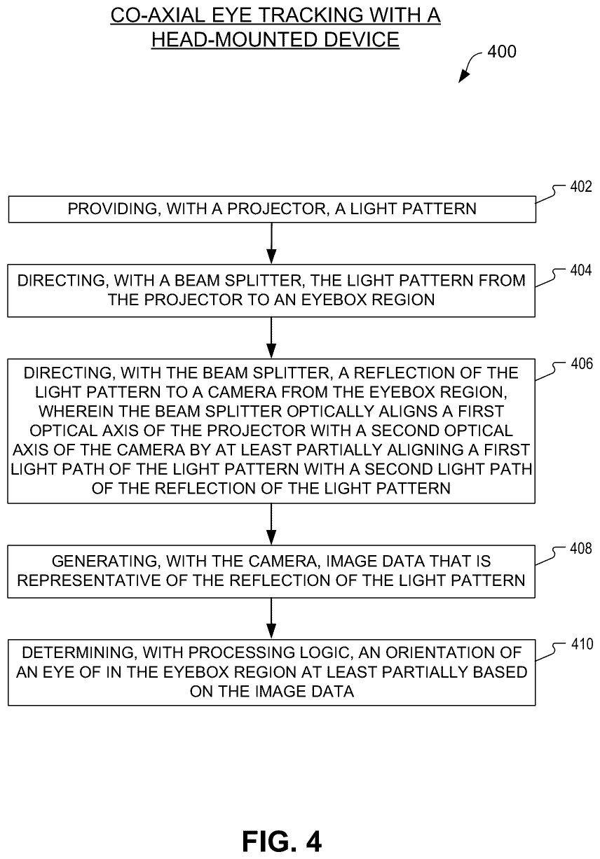

FIG. 4. illustrates an example of a process 400 for co-axial eye tracking in a head-mounted display, in accordance with aspects of the disclosure. Process 400 may be at least partially incorporated into or performed by an eye tracking system, according to an embodiment. The order in which some or all of the process blocks appear in process 400 should not be deemed limiting. Rather, one of ordinary skill in the art having the benefit of the present disclosure will understand that some of the process blocks may be executed in a variety of orders not illustrated, or even in parallel.

At process block 402, process 400 includes providing, with a projector, a light pattern, according to an embodiment. Process block 402 proceeds to process block 404, according to an embodiment.

At process block 404, process 400 includes directing, with a beam splitter, the light pattern from the projector to an eyebox region, according to an embodiment. Process block 404 proceeds to process block 406, according to an embodiment.

At process block 406, process 400 includes directing, with the beam splitter, a reflection of the light pattern to a camera from the eyebox region, wherein the beam splitter optically aligns a first optical axis of the projector with a second optical axis of the camera by at least partially aligning a first light path of the light pattern with a second light path of the reflection of the light pattern, according to an embodiment. Process block 406 proceeds to process block 408, according to an embodiment.

At process block 408, process 400 includes generating, with the camera, image data that is representative of the reflection of the light pattern, according to an embodiment. Process block 408 proceeds to process block 410, according to an embodiment.

At process block 410, process 400 includes determining, with processing logic, an orientation of an eye of in the eyebox region at least partially based on the image data, according to an embodiment. The eye orientation may include a relative eye orientation or an absolute eye orientation. Process 400 may further include capturing multiple images of the reflection of the light pattern, comparing changes in fringe lines of the light pattern, and determining the orientation of the eye at least partially based on the changes in the fringe lines.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g., 128) in this disclosure may include one or more processors, microprocessors, multi-core processors, Application-specific integrated circuits (ASIC), and/or Field Programmable Gate Arrays (FPGAs) to execute operations disclosed herein. In some embodiments, memories are integrated into the processing logic to store instructions to execute operations and/or store data. Processing logic may also include analog or digital circuitry to perform the operations in accordance with embodiments of the disclosure.

A “memory” or “memories” (e.g., 130) described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

A network may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels (e.g., between projector 106, controller 112, camera 110) may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. An eye tracking system comprising:
a projector configured to emit a light pattern along a first light path to an eyebox region;
a camera configured to capture an image of a reflection of the light pattern along a second light path from the eyebox region; and
a beam splitter positioned to at least partially align the first light path with the second light path so a first optical axis of the projector is optically co-axial with a second optical axis of the camera with respect to the eyebox region.

2. The eye tracking system of claim 1, wherein the beam splitter is positioned within the first light path and within the second light path, wherein the beam splitter at least partially defines the first light path or the second light path.

3. The eye tracking system of claim 1, wherein the light pattern includes at least one of a straight-line fringe pattern, a circular pattern, or a dot pattern.

4. The eye tracking system of claim 1, wherein the beam splitter is a 50-50 beam splitter or a polarization beam splitter.

5. The eye tracking system of claim 1, wherein the projector is configured to emit the light pattern with a first polarization orientation, wherein the reflection of the light pattern includes a second polarization orientation, wherein the camera is configured to capture the image of the reflection of the light pattern having the second polarization orientation, wherein the beam splitter is configured to redirect light having the first polarization orientation and is configured to transmit light having the second polarization orientation.

6. The eye tracking system of claim 1 further comprising:
processing logic communicatively coupled to the projector and the camera, wherein the processing logic is configured to determine an orientation of an eye of a user based on the image.

7. The eye tracking system of claim 6, wherein the processing logic determines the orientation of the eye at least partially based on at least one of: a displacement of lines in the light pattern, a rate of displacement of the light pattern, or a distortion of the light pattern.

8. The eye tracking system of claim 1, wherein the projector emits the light pattern in an infrared wavelength, wherein the camera includes a filter to capture the light pattern having the infrared wavelength.

9. A head-mounted device comprising:
a frame; and
an eye tracking system at least partially coupled to the frame, wherein the eye tracking system includes:
a projector configured to emit a light pattern along a first light path to an eyebox region;
a camera configured to capture an image of a reflection of the light pattern along a second light path from the eyebox region; and
a beam splitter positioned to optically align a first optical axis of the projector with a second optical axis of the camera,
wherein the beam splitter at least partially aligns the first light path with the second light path to be co-axial.

10. The head-mounted device of claim 9, wherein the beam splitter is carried by the frame and is oriented to receive the reflection of the light pattern from the eyebox region.

11. The head-mounted device of claim 9, wherein the light pattern includes one or more of a straight-line fringe pattern, a circular pattern, or a dot pattern.

12. The head-mounted device of claim 9, wherein the beam splitter is a 50-50 beam splitter or a polarization beam splitter.

13. The head-mounted device of claim 9, wherein the projector is configured to emit the light pattern with a first polarization orientation, wherein the camera is configured to capture the image with a second polarization orientation, wherein the beam splitter is configured to redirect light having the first polarization orientation and is configured to transmit light having the second polarization orientation.

14. The head-mounted device of claim 9 further comprising:
processing logic coupled to the projector and the camera, wherein the processing logic is configured to determine an orientation of an eye of a user based on the image.

15. The head-mounted device of claim 9, wherein the projector emits the light pattern in an infrared wavelength, wherein the camera includes a filter to capture the light pattern in the infrared wavelength.

16. A method of co-axial eye tracking with a head-mounted device comprising:
providing, with a projector, a light pattern;
directing, with a beam splitter, the light pattern from the projector to an eyebox region;
directing, with the beam splitter, a reflection of the light pattern to a camera from the eyebox region,
wherein the beam splitter optically aligns a first optical axis of the projector with a second optical axis of the camera by at least partially aligning a first light path of the light pattern with a second light path of the reflection of the light pattern;
generating, with the camera, image data that is representative of the reflection of the light pattern; and
determining, with processing logic, an orientation of an eye of in the eyebox region at least partially based on the image data.

17. The method of claim 16, wherein determining the orientation of the eye includes:
capturing multiple images of the reflection of the light pattern;
comparing changes in fringe lines of the light pattern; and
determining the orientation of the eye based on the changes in the fringe lines.

18. The method of claim 17, wherein changes in the fringe lines includes a phase change for the fringe lines or includes shifts in frequency components between the multiple images.

19. The method of claim 16 further comprising:
displaying user interface elements on a display of the head-mounted device; and
updating the user interface elements based on the orientation of the eye.

20. The method of claim 16, wherein the beam splitter is a 50-50 beam splitter or a polarization beam splitter.
